(19) United States
(12) Patent Application Publication
(10) Pub. No.: US 2006/0243257 A1
(43) Pub. Date: Nov. 2, 2006

(54) Engine and method of operating the same

(75) Inventors: Pete W. Freund, Bloomington, MN (US); Mark Rabine, Farmington, MN (US); Scott Rayman, Plymouth, MN (US)

Correspondence Address: MICHAEL BEST & FRIEDRICH, LLP, 100 E WISCONSIN AVENUE, MILWAUKEE, WI, 53202, US

(73) Assignee: Thermo King Corporation, Minneapolis, MN (US)

(21) Appl. No.: 11/402,462

(22) Filed: Apr. 12, 2006

Related U.S. Application Data
(60) Provisional application No. 60/670,903, filed on Apr. 13, 2005.

(51) Int. Cl. F02G 5/00; F02M 1/00

(52) U.S. Cl. 123/550; 123/179.16

(57) ABSTRACT

A method of operating an internal combustion engine of a vehicle in an environment having an ambient temperature below about 0 degrees Celsius. The engine can include a battery and an engine body supporting a piston. The method can include the acts of initiating a first heating operation to warm air entering the engine, igniting fuel in the engine body to warm the engine and causing limited movement of the piston relative to the engine body, drawing power from the battery to generate heat in the battery, distributing the heat through the battery for a predetermined period of time before initiating a second heating operation to warm the air in the engine, and starting the internal combustion engine after the heat is distributed through the battery, causing the piston to continually reciprocate through the engine body.

### RELATED APPLICATIONS

This application claims the benefit of prior-filed, co-pending U.S. Provisional Patent Application Ser. No. 60/670,903 filed on Apr. 13, 2005, the entire content of which is incorporated by reference herein.

### FIELD OF THE INVENTION

The invention relates to internal combustion engines and, more particularly, to an internal combustion engine and to a method of starting internal combustion engines in cold environments.

### SUMMARY

Some embodiments of the present invention provide a method of operating an internal combustion engine of a vehicle in an environment having an ambient temperature below about 0 degrees Celsius. The engine can include a battery and an engine body supporting a piston. The method can include the acts of initiating a first heating operation to warm air entering the engine, and igniting fuel in the engine body to warm the engine and causing limited movement of the piston relative to the engine body. The method can also include drawing power from the battery to generate heat in the battery, and distributing the heat through the battery for a predetermined period of time before initiating a second heating operation to warm the air in the engine. The method can also include starting the internal combustion engine after the heat is distributed through the battery, causing the piston to continually reciprocate through the engine body.

The present invention also provides an internal combustion engine of a vehicle. The internal combustion engine can include an engine body having an air inlet, a sensor for recording an ambient temperature away from the engine body, and a heater positioned adjacent to the air inlet for heating air entering the engine body. The internal combustion engine can also include a piston supported in the engine body for reciprocating movement through the engine body, a battery electrically connected to the heater to supply power to the heater, and a controller operable to activate the heater to warm air entering the engine, initiate combustion of fuel in the engine body to warm the engine without causing continued movement of the piston relative to the body, and draw power from the battery before starting the engine. The controller can be operable to delay starting of the engine for a predetermined time to allow heat to be distributed through the battery before causing the piston to continually reciprocate through the engine body.

In addition, some embodiments of the present invention provide a method of operating an internal combustion engine of a vehicle in an environment having an ambient temperature of below about 0 degrees Celsius. The engine can include a battery and an engine supporting a piston. The method can include the acts of activating a heating element to warm the engine body, cranking the engine to warm the engine and causing limited movement of the piston relative to the engine body, drawing power from the battery to generate heat in the battery, and distributing the heat through the battery for a predetermined period of time before starting the internal combustion engine and causing the piston to continually reciprocate through the body.

Other aspects of the invention will become apparent by consideration of the detailed description and accompanying drawings.

### BRIEF DESCRIPTION OF THE DRAWINGS

FIG. 1 illustrates a vehicle having an internal combustion engine and a temperature control system according to some embodiments of the present invention.

FIG. 2 is a schematic representation of the temperature control system shown in FIG. 1.

FIG. 3 is a schematic representation of the internal combustion engine shown in FIG. 1.

FIGS. 4-9 illustrate a method of operating the internal combustion engine shown in FIG. 1.

FIG. 10 is a plot of engine speed versus time for a first successful start of an engine.

FIG. 11 is a plot of engine speed versus time for a second successful start of an engine.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models and/or graphic representations of systems and methods of operating systems. As noted, many of the modules and logical structures described herein are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the coding examples and drawings. However, no specific meaning is implied or should be inferred simply due to the use of capitalization. Thus, the claims should not be limited to the specific examples or terminology or to any specific hardware or software implementation or combination of software or hardware.

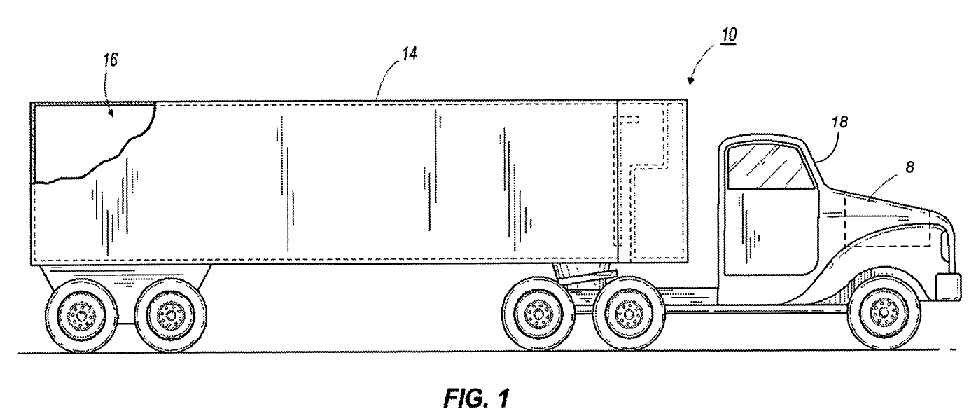

FIG. 1 illustrates a vehicle 18 including an internal combustion engine 8 and a temperature control system 10 according to some embodiments of the present invention. In the illustrated embodiment of FIG. 1, the vehicle 18 is a tractor for pulling a trailer 14 having a load space 16. In other embodiments, other vehicles (e.g., trucks, buses, vans, and the like) can also or alternately be used.

As used herein, the term “load space” includes any space to be temperature and/or humidity controlled, including transport and stationary applications for the preservation of food, beverages, plants, flowers, and other perishables and maintenance of a desired atmosphere for the shipment of industrial products. Also, as used herein, the term “refrigerant” includes any conventional refrigeration fluid, such as, for example, chloroflourocarbons (CFCs), hydrocarbons, cryogens (e.g., CO2, and N2), etc. In addition, as used herein, the term “refrigerant” refers to fluids commonly used for heating and defrosting purposes.

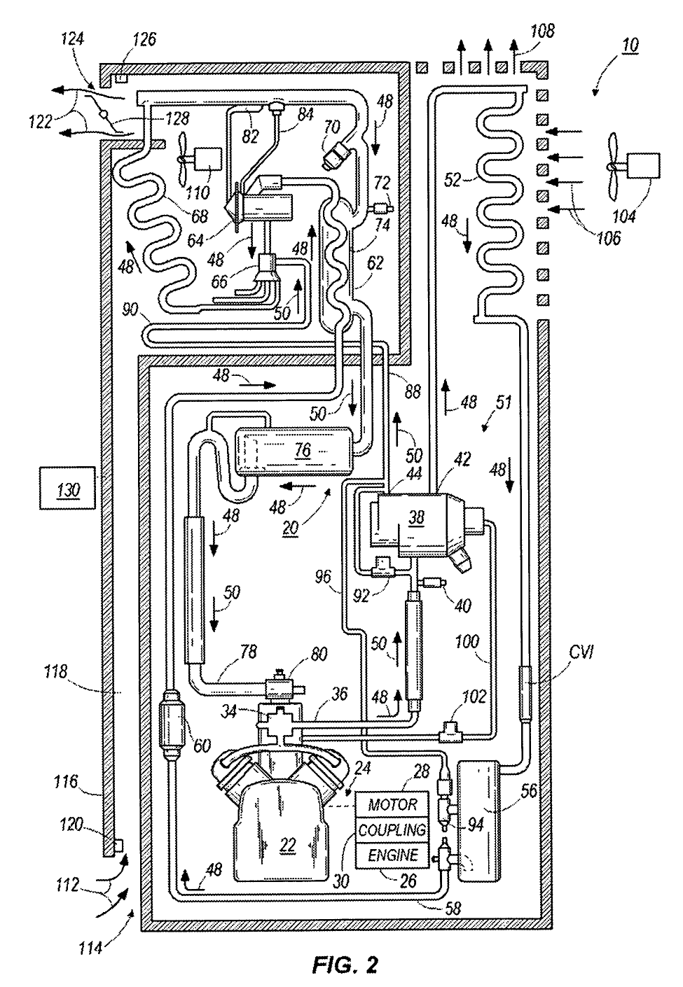

The temperature control system 10 controls the temperature of the load space 16 to a desired temperature range adjacent to a predetermined set point temperature. More particularly, the temperature control system 10 maintains the temperature of the load space 16 within a range surrounding the set point temperature (e.g., ±5° F.). As shown in FIG. 2, the temperature control system 10 includes a closed refrigerant circuit or flow path 20 having a refrigerant compressor 22 driven by a drive unit 24. In the illustrated embodiment of FIG. 2, the drive unit 24 includes an internal combustion engine 26 and a stand-by electric motor 28. The engine 26 and the motor 28, when both are utilized, are connected to the compressor 22 by a clutch or coupling 30 which disengages the engine 26 while the motor 28 is in operation.

In some embodiments, such as the illustrated embodiment of FIG. 2, the temperature control system 10 can include a dedicated engine 26. In other embodiments, the vehicle engine 8 can also or alternately supply power to the temperature control system 10 or elements of the temperature control system 10.

A discharge valve 34 and a discharge line 36 connect the compressor 22 to a three-way valve 38. A discharge pressure transducer 40 is located along the discharge line 36, upstream from the three-way valve 38 to measure the discharge pressure of the compressed refrigerant. The three-way valve 38 includes a first outlet port 42 and a second outlet port 44.

When the temperature control system 10 is operated in a cooling mode, the three-way valve 38 is adjusted to direct refrigerant from the compressor 22 through the first outlet port 42 and along a first circuit or flow path (represented by arrows 48). When the temperature control system 10 is operated in heating and defrost modes, the three-way valve 28 is adjusted to direct refrigerant through the second outlet port 44 and along a second circuit or flow path (represented by arrows 50).

The first flow path 48 extends from the compressor 22 through the first outlet port 42 of the three-way valve 38, a condenser coil 52, a one-way condenser check valve CV1, a receiver 56, a liquid line 58, a refrigerant drier 60, a heat exchanger 62, an expansion valve 64, a refrigerant distributor 66, an evaporator coil 68, an electronic throttling valve 70, a suction pressure transducer 72, a second path 74 through the heat exchanger 62, an accumulator 76, a suction line 78, and back to the compressor 22 through a suction port 80. The expansion valve 64 is controlled by a thermal bulb 82 and an equalizer line 84.

The second flow path 50 can bypass a section of the refrigeration circuit 51, including the condenser coil 52 and the expansion valve 64, and can connect the hot gas output of compressor 22 to the refrigerant distributor 66 via a hot gas line 88 and a defrost pan heater 90. The second flow path 50 continues from the refrigerant distributor 66 through the evaporator coil 68, the throttling valve 70, the suction pressure transducer 72, the second path 74 through the heat exchanger 62, and the accumulator 76 and back to the compressor 22 via the suction line 78 and the suction port 80.

A hot gas bypass valve 92 is disposed to inject hot gas into the hot gas line 88 during operation in the cooling mode. A bypass or pressurizing line 96 connects the hot gas line 88 to the receiver 56 via check valves 94 to force refrigerant from the receiver 56 into the second flow path 50 during operation in the heating and defrost modes.

Line 100 connects the three-way valve 38 to the low-pressure side of the compressor 22 via a normally closed pilot valve 102. When the valve 102 is closed, the three-way valve 38 is biased (e.g., spring biased) to select the first outlet port 42 of the three-way valve 38. When the evaporator coil 52 requires defrosting and when heating is required, valve 92 is energized and the low pressure side of the compressor 22 operates the three-way valve 38 to select the second outlet port 44 to begin operation in the HEATING mode and/or defrost modes.

A condenser fan or blower 104 directs ambient air (represented by arrows 106) across the condenser coil 52. Return air (represented by arrows 108) heated by contact with the condenser fan 104 is discharged to the atmosphere. An evaporator fan 110 draws load space air (represented by arrows 112) through an inlet 114 in a bulkhead or wall 116 and upwardly through conduit 118. A return air temperature sensor 120 measures the temperature of air entering the inlet 114.

Discharge air (represented by arrow 122) is returned to the load space 14 via outlet 124. Discharge air temperature sensor 126 is positioned adjacent to the outlet 124 and measures the discharge air temperature. During the defrost mode, a damper 128 is moved from an opened position (shown in FIG. 2) toward a closed position (not shown) to close the discharge air path to the load space 14.

The temperature control system 10 also includes a controller 130 (e.g., a microprocessor). The controller 130 receives data from sensors, including the return air temperature sensor 124 and the discharge air temperature sensor 126. Additionally, given temperature data and programmed parameters, the controller 130 determines whether cooling, heating, or defrosting is required by comparing the data collected by the sensors with the set point temperature.

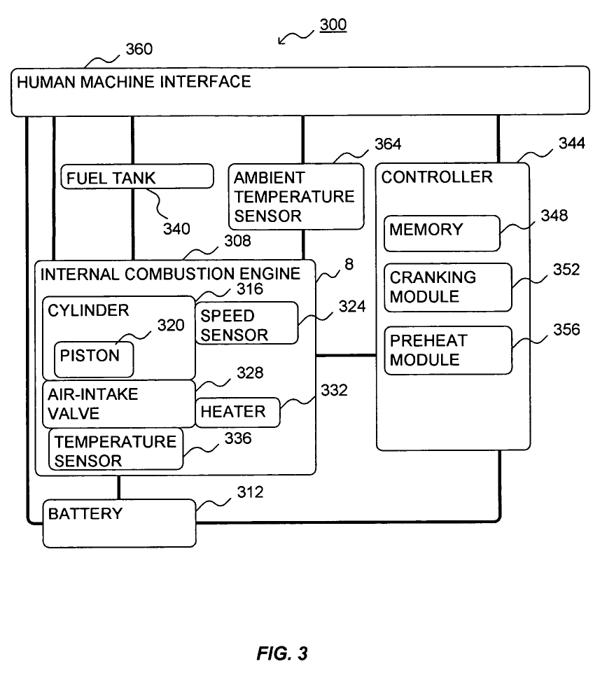

FIG. 3 illustrates an engine control system 300 for use with the engine 8 and, in some embodiments, for use with the temperature control system 10. The internal combustion engine 8 of the illustrated embodiment of FIG. 3 is a diesel engine. In other embodiments, other engines, including gasoline engines, rotary engines, and the like can also or alternately be used.

As shown in FIG. 3, the internal combustion engine 8 can include an engine body 308 and a battery 312. The engine body 308 can also include cylinders 316 for supporting pistons 320. Each of the cylinders 316 can include a speed sensor 324 and an air-intake valve 328 for drawing ambient air into the engine body 308. A heater 332 and a temperature sensor 336 can be mounted adjacent to or on the engine body 308. In the illustrated embodiment of FIG. 3, the heater is an 800-watt electrical air heater. In other embodiments, other conventional heaters, including gas, chemical, and solar powered heaters can also or alternately be used.

The engine 8 can also include a fuel tank 340 for supplying fuel to the cylinders 316 and a controller 344. In the illustrated embodiment of FIG. 3, the controller 344 includes a computer readable medium 348, a cranking module 352, and a preheat module 356. The controller 344 can be a general-purpose micro-controller, a general-purpose microprocessor, a dedicated microprocessor or controller, a signal processor, an application-specific-integrated circuit (“ASIC”), and the like. In some embodiments, the temperature control system 10 and its functions or modules described are implemented in a combination of firmware, software, hardware, and the like. More particularly, as illustrated in FIG. 3, the controller 344 communicates with other modules (discussed below) and components that are depicted as if these modules were implemented in hardware. However, the functionality of these modules could be implemented in software, and that software could, for example, be stored in the computer readable medium 348 and executed by the controller 344. In addition, although the computer readable medium 348 is shown as a memory embedded in the controller 344, the computer readable medium 348 can also be an external memory. The engine control system 300 can also include other components such as a water pump, an oil pump, an alternator, an exhaust system, ignition coils, a distributor, and the like. Operation of the engine control system 300 is detailed hereinafter. Furthermore, the engine control system 300 can include a human-machine interface (“HMI”) 360 to interface between a user and the components and modules of the engine control system 300. In some embodiments, the HMI 360 includes keypads, displays, and the like.

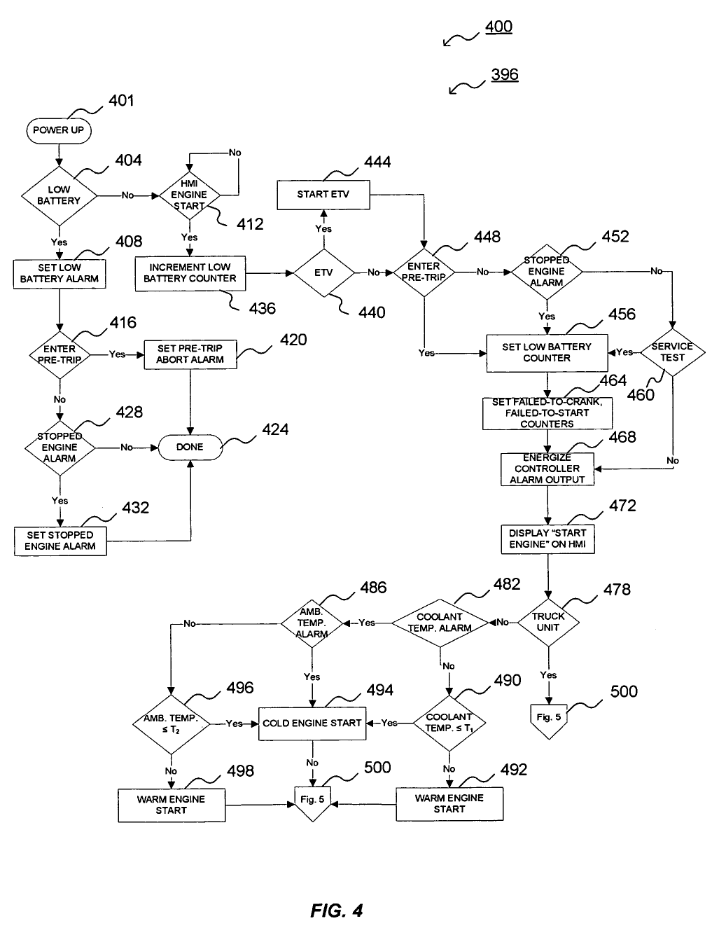

FIGS. 4-9 illustrate a method 396 of operating the engine 8 and the engine control system 300 of the present invention. At least portions of the method 39 can be carried out by or using software, firmware, and hardware.

FIG. 4 illustrates an enable sub-process 400 of the method 396. At block 401, the engine control system 300 is activated or powered up. At block 404, the engine control system 300 senses the charge of the battery 312 to determine if the charge of the battery 312 is below a required power charge C₁. If the enable sub-process 400 determines that the charge of the battery 312 is below the required power charge C₁ (“Yes” at block 404), an alarm is set at block 408.

If the enable sub-process 400 determines that the charge of the battery 312 is above the required power charge, (“No” at block 404), the enable sub-process 400 proceeds to determine if the HMI 360 has allowed the engine 8 to start at block 412. If the enable sub-process 400 determines that HMI 360 has not allowed the engine 8 to start at block 412 (“No” at block 412), the enable sub-process 400 enters a loop to wait until the HMI 360 has allowed the engine 8 to start (i.e, the enable sub-process 400 can be programmed to prevent further operation until receiving authorization from an operator).

After the enable sub-process 400 has set the alarm at block 408, the enable sub-process 400 determines if the engine control system 300 is set to enter a pre-trip mode at block 416. If the enable sub-process 400 determines that the engine control system 300 is set to a pre-trip mode at block 416 (“Yes” at block 416), an alarm corresponding to a pre-trip mode is set at block 420, and the enable sub-process 400 or the engine starting process 396 terminates at block 424. However, if the enable sub-process 400 determines that the engine control system 300 has not been set to a pre-trip mode at block 416 (“No” at block 416), the enable sub-process 400 determines if an alarm corresponding to a stopped engine has been set at block 428. If the enable sub-process 400 determines that the alarm corresponding to a stopped engine has not been set at block 428 (“No” at block 428), the alarm is set at block 432 before the enable sub-process 400 proceeds to block 424.

Referring back to block 412, if the enable sub-process 400 determines that the HMI 360 has allowed the engine 8 to start at block 412 (“Yes” at block 412), the enable sub-process 400 increments a low battery counter at block 436. The enable sub-process 400 then determines if the temperature control system 10 is equipped with an electronic throttle valve (“ETV”) at block 440.

If the enable sub-process 400 determines that the temperature control system 10 is equipped with an ETV (“Yes” at block 440), the enable sub-process 400 starts any ETV test processes scheduled for the temperature control system 10 at block 444. However, if the enable sub-process 400 determines that the temperature control system 10 is not equipped with an ETV (“No” at block 440), or alternatively, when the enable sub-process 400 has finished the ETV test processes scheduled for the temperature control system 10 at block 444, the enable sub-process 400 proceeds to determine if the temperature control system 10 has been set to a pre-trip mode at block 448.

If the enable sub-process 400 determines that the engine control system 300 is not set to enter a pre-trip mode (“No” at block 448), the enable sub-process 400 determines if an alarm corresponding to a stopped engine is set at block 452. However, if the enable sub-process 400 determines that the engine control system 300 is set to enter a pre-trip mode (“Yes” at block 448), or alternatively, if the enable sub-process 400 determines that an alarm corresponding to a stopped engine is set (“Yes” at block 452), the enable sub-process 400 sets the low battery counter to a predetermined number (e.g., 3) at block 456. However, if the enable sub-process 400 determines that an alarm corresponding to a stopped engine is not set (“No” at block 452), the enable sub-process 400 proceeds to determine if the temperature control system 10 is in a testing mode. If the enable sub-process 400 determines that the temperature control system 10 is in a testing mode (“Yes” at block 460), the enable sub-process 400 proceeds to block 456.

After the low battery counter has been set to the predetermined number at block 456, the enable sub-process 400 sets a failed-to-crank counter and a failed-to-start counter at block 464. Thereafter, or if the enable sub-process 400 determines that the temperature control system 10 is not in a testing mode (“No” at block 460), the enable sub-process 400 energizes an alarm output at block 468 to signal to an operator that the engine control system 300 is prepared to start.

Subsequently, the enable sub-process 400 displays operator readable information, such as, for example, “start engine” at the HMI 360 at block 472. The enable sub-process 400 then determines at block 478 if the temperature control system 10 is a truck unit. In some embodiments, truck units can include a single internal combustion engine 8 that supplies power and/or heating/defrosting heat to the temperature control system 10. In other embodiments (e.g., trailer units), the temperature control system 10 can include a dedicated internal combustion engine and the vehicle 14 can include a second internal combustion engine for powering the vehicle.

If the enable sub-process 400 determines that the temperature control system 10 is a truck unit (“Yes” at block 478), the enable sub-process 400 enters a preheat process (explained in greater detail below). However, if the enable sub-process 400 determines that the temperature control system 10 is not a truck unit (“No” at block 478, the enable sub-process 400 determines at block 482 if an alarm corresponding to an engine coolant temperature sensor is operating.

If the enable sub-process 400 determines that an alarm corresponding to engine coolant temperature sensor is set (“Yes” at act 482), the enable sub-process 400 determines at block 486 if an alarm corresponding to ambient temperature sensor has been set. However, if the enable sub-process 400 determines that an alarm corresponding to engine coolant temperature sensor is not set (“No” at block 482), the enable sub-process 400 determines at block 490 if the temperature of the engine coolant is below a first threshold temperature T₁ (e.g., about −7° C.).

If the enable sub-process 400 determines that the temperature of the engine coolant is greater than the first threshold temperature T₁ (“No” at block 490), the enable sub-process 400 proceeds to start the engine 8 in a warm start mode at block 492. If the temperature of the coolant in the engine 8 is below or equal to the first threshold temperature T₁ (“Yes” at block 490), or alternatively, if the alarm corresponding to the ambient temperature sensor has been set (“Yes” at block 486), the enable sub-process 400 enters the cold start mode at block 494.

If the alarm corresponding to the ambient temperature sensor has not been set (“No” at block 486), the enable sub-process 400 determines if the ambient temperature is below a second threshold temperature T₂ (e.g., 10° C.) at block 496. If the ambient temperature is below the second threshold temperature T₂ (“Yes” at block 496), the enable sub-process 400 enters a cold start mode at block 494. If the ambient temperature is greater than or equal to the second threshold temperature T₂ (“No” at block 496), the enable sub-process 400 proceeds to start the engine 8 in a warm start mode at block 498.

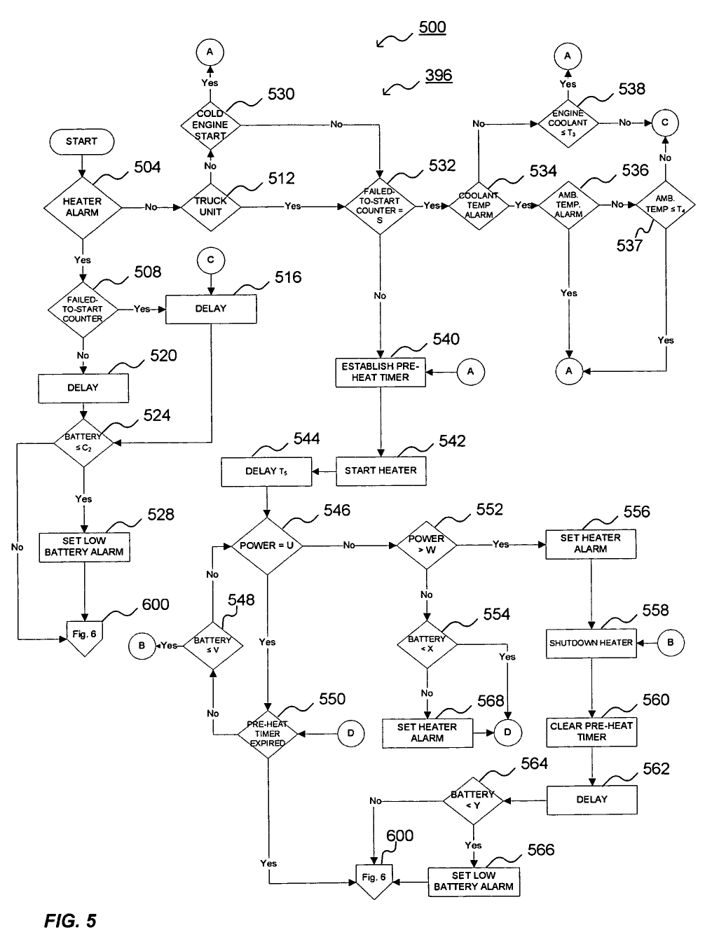

FIG. 5 illustrates a preheat sequence or a preheat sub-process 500 of the engine starting process 396. In some embodiments, the heater 332 preheats an air intake chamber and/or air adjacent to or in the air-intake valve 328. In these embodiments, warm air enters the engine body 308 before the engine 8 is started and/or cranked. In some embodiments, the preheat sequence can lasts for between about 40 seconds and about 60 seconds, depending on one or more of the engine size, the ambient temperature, and the battery charge.

In other embodiments, the heater 332 can be activated for a first preheat sequence and a second preheat sequence a short time after the first preheat sequence is completed. In some such embodiments, the sequence can include a delay between the first and second preheat sequences to allow heat generated during the preheating sequence to be distributed through the battery 312 and/or the engine body 308. In some embodiments, the delay can lasts for between about 20 seconds and about 40 seconds (e.g., about 30 seconds), depending on one or more of the engine size, the ambient temperature, and the battery charge.

With reference to block 504 in FIG. 5, the preheat sub-process 500 can determine if an alarm corresponding to a failure of the heater 332 is set. If the alarm is set (“Yes” at block 504), the preheat sub-process 500 determines at block 508 if the failed-to-start counter is set to a predetermined number (e.g., 1). Otherwise, if an alarm corresponding to a failure of the heater 332 is not set (“No” at block 504), the preheat sub-process 500 determines at block 512 if the temperature control system 10 is a truck unit.

If the failed-to-start counter is set to the predetermined number (“Yes” at block 508), the preheat sub-process 500 initiates a delay for a period of time (e.g., about 10 seconds) at block 516. However, if the failed-to-start counter is not set to the predetermined number (“No” at block 508), the preheat sub-process 500 initiates another delay for a period of time (e.g., about 20 seconds) at block 520.

After the delay at block 516, or alternately, after the delay at block 520, the preheat sub-process 500 senses the charge of the battery 312 to determine if the charge of the battery 312 is below a threshold power charge C₂ (e.g., about 10.5 volts) at block 524. If the preheat sub-process 500 determines that the charge of the battery 312 is below the threshold power charge C₂ (“Yes” at block 524), the sub-process 500 sets an alarm corresponding to low battery charge at block 528. If the charge of the battery 312 is above the threshold power charge C₂ (“No” at block 524), or alternatively, after the sub-process 500 sets an alarm corresponding to low battery charge at block 528, the sub-process 500 enters a pre-crank sequence (described in greater detail below).

If the temperature control system 10 is not a truck unit (“No” at block 512), the sub-process 500 determines if the engine 8 is to start in the cold start mode at block 530. If the engine 8 is to start in the cold start mode at block 530 (“Yes” at block 530), the preheat sub-process 500 establishes a preheat time PH (described below). However, if the engine 8 is not to start in the cold start mode (“No” at block 530), or alternatively, if the temperature control system 10 is a truck unit (“Yes” at block 512), the preheat sub-process 500 determines if the failed-to-start counter reaches a predetermined number S (e.g., 1 or 2) at block 532.

If the failed-to-start counter has reached the predetermined number S, the preheat sub-process 500 determines at block 534 if an alarm corresponding to coolant temperature sensor failure has been set. If the alarm corresponding to coolant temperature sensor failure has been set (“Yes” at block 534), the preheat sub-process 500 determines at block 536 if the ambient temperature sensor has failed. Otherwise, if the alarm corresponding to coolant temperature sensor failure has not been set (“No” at block 534), the preheat sub-process 500 determines at block 538 if the engine coolant temperature is below a threshold value T₃ (e.g., about 10° C.). If the coolant temperature is below the threshold value T₃ (“Yes” at block 538), the preheat sub-process 500 establishes a preheat time PH (described below). Otherwise, if the coolant temperature is not below the threshold value T₃ (“No” at block 538), the preheat sub-process 500 returns to block 516.

If the ambient temperature sensor has failed at block 536 (“Yes” at block 536), the preheat sub-process 500 enters a second pre-crank sequence at block 540. If the ambient temperature sensor has not failed (“No” at block 536), the preheat sub-process 500 determines at block 537 if the ambient temperature recorded by the ambient temperature sensor 364 is below a fourth threshold value T₄ (e.g., about 10° C.). If the ambient temperature is below the fourth threshold value T₄ (“Yes” at 537), the preheat sub-process 500 establishes a preheat time PH (described below). Otherwise, if the ambient temperature is not below the fourth threshold value T₄ (“Yes” at block 537), the preheat sub-process 500 returns to block 516.

Referring back to block 532, if the failed-to-start counter has not been set to the predetermined number S, if the preheat sub-process 500 determines that the engine 8 is starting cold (“Yes” at block 530), and/or if the engine coolant is below the third threshold value T₃ (“Yes” at block 538), the preheat sub-process 500 establishes a preheat time PH at block 540. Subsequently, the preheat sub-process 500 energizes a preheat output (e.g., the heater 332) at block 542, and enters a delay for a period of time T₅ (e.g., about 7 seconds) at block 544 to allow the engine control system 300 to stabilize.

The preheat sub-process 500 then determines at block 546 if the heater 332 is drawing a first predetermined threshold of power U from the battery 312. The first predetermined threshold of power drawn depends on the size and power of the engine 8 and/or the battery 312. For example, a current drawn of between about 50 and 83 amps is considered allowable or acceptable for a 2.1 L Trailer Yanmar engine. On the other hand, a power drawn of more than 38 amps is unacceptable for a truck Yanmar 395 engine.

If the heater 332 is drawing the first predetermined threshold of power U from the battery 312 (“Yes” at block 546), the preheat sub-process 500 determines if the preheat time or the preheat timer has expired at block 550. If the preheat timer has not expired at block 550 (“No” at block 550), the preheat sub-process 500 determines if the battery charge is below a second predetermined threshold V. If the battery charge is not below the second predetermined threshold (“No” at block 548), the preheat sub-process 500 returns to block 546. However, if the preheat timer has expired (“Yes” at block 550), the preheat sub-process 500 enters a pre-crank sequence (described below).

On the other hand, if the heater 332 is not drawing the first predetermined threshold of power U from the battery 312 (“No” at block 546), the preheat sub-process 500 determines if the heater 332 is drawing above a predetermined third predetermined threshold of power W from the battery 312 at block 552. If the heater 332 is not drawing above the third predetermined threshold of power W from the battery 312 (“No” at block 552), and if the battery level is below a fourth predetermined power X (e.g., about 11.2 volts) (“Yes” at block 554, the preheat sub-process 500 returns to block 550.

However, if the heater 332 is drawing above the third predetermined threshold of power W from the battery 312 (“Yes” at block 552), the preheat sub-process 500 sets an alarm corresponding to checking the heater 332 at block 556. Subsequently, the preheat sub-process 500 de-energizes the outputs of the heater 332 at block 558. The preheat sub-process 500 then clears the preheat timer at block 560, and enters a delay (e.g., about 7 seconds), at block 562.

After the delay at block 562, the preheat sub-process 500 determines if the battery charge is below a fifth predetermined power threshold Y (e.g., about 10.5 volts) at block 564. If the battery charge is below the fifth predetermined power threshold Y (“Yes” at block 564), the preheat sub-process 500 sets an alarm corresponding to low battery voltage at block 566, and enters the pre-crank sequence. However, if the battery charge is not below the fifth predetermined power threshold Y, the preheat sub-process 500 enters the pre-crank sequence.

Referring back to block 548, if the battery level is less than the second predetermined threshold V (“Yes” at block 548), the preheat sub-process 500 returns to block 558. As for block 554, if the battery charge is not below the fourth predetermined threshold X (“No” at block 554), the preheat sub-process 500 sets an alarm corresponding to checking the heater 332 at block 568, and repeats block 550.

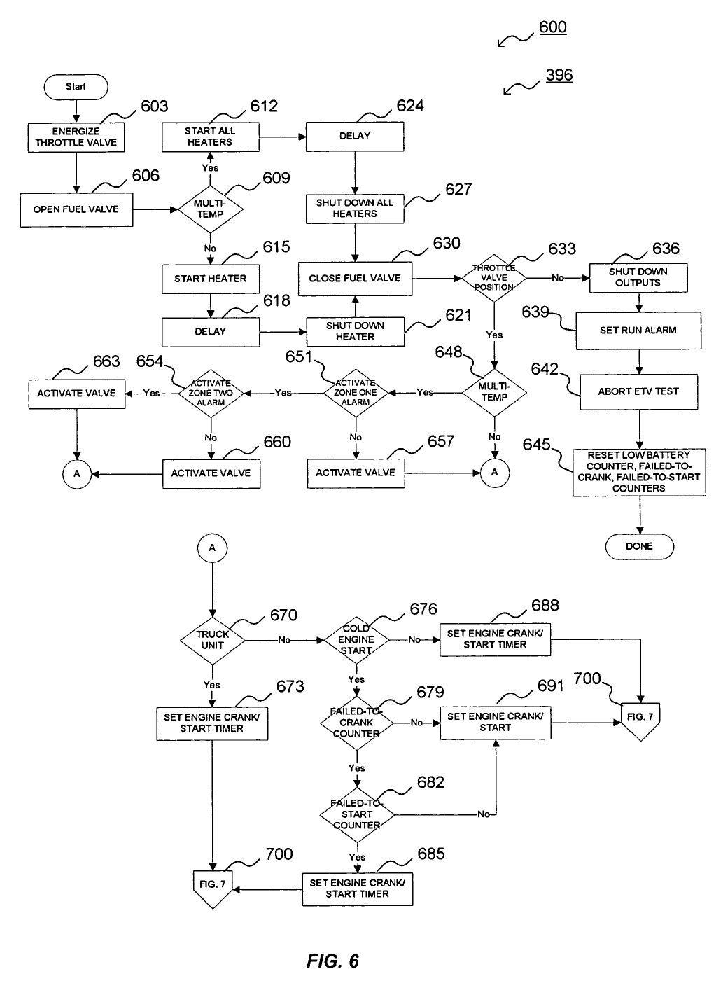

FIG. 6 illustrates a pre-crank sequence or a pre-crank sub-process 600 of the engine starting process 396. In a typical pre-crank sequence, the engine is cranked for a short period of time. At block 603, the pre-crank process 600 energizes a run relay output. The pre-crank sub-process 600 also energizes a fuel control valve such that fuel can be pumped into the cylinders 316 from the fuel tank 340, at block 606.

The pre-crank sub-process 600 then determines if the temperature control system 10 is a multi-temperature zone unit at block 609 (i.e., if the temperature control system 10 is operable to control the temperature and/or humidity in two or more different load spaces 16). If the temperature control system 10 is a multi-temperature zone unit (“Yes” at block 609), the pre-crank sub-process 600 energizes all hot gas outputs in all zones in the temperature control system 10 at block 612. However, if the temperature control system 10 is not a multi-temperature unit (“No” at block 609), the pre-crank sub-process 600 starts the heater 332 at block 615, enters a delay for a predetermined period of time (e.g., about 2 seconds) at block 618, and shuts down the heater 332 at block 621. The pre-crank sub-process 600 then closes the fuel valve at block 630. After the pre-crank sub-process 600 activates the heaters 312 in all zones provided in the temperature control system 10 at block 612, the pre-crank sub-process 600 enters a delay for a predetermined period of time (e.g., about 2 seconds) at block 624, and shuts down the heaters in all zones at block 627.

Subsequently, the pre-crank sub-process 600 determines if a fuel throttle valve is in a predetermined position at block 633. If the throttle valve is not in the predetermined position at block 633, the pre-crank sub-process 600 aborts the engine starting process 396.

In some embodiments, in aborting the engine starting process 396, the pre-crank sub-process 600 shuts down all of the system outputs or substantially all of the system outputs, sets a run alarm at block 639, aborts any ETV scheduled tests, and resets at least one of the counters (e.g., the low battery counter, failed-to-crank counter, and failed-to-start counter) at block 645, and terminates the pre-crank sub-process 600. In some other embodiments, in aborting the starting process 396, the pre-crank sub-process 600 also aborts the tests performing on the suction pressure transducer 72.

Referring back to block 648, if the temperature control system 10 is a multi-temperature zone unit (“Yes” as block 648), the pre-crank sub-process 600 activates alarms corresponding to fuels valves for the various zones of the system at blocks 651 and 654, respectively. If one or more of the alarms have not been set (“No” at blocks 651, 654), the pre-crank sub-process 600 activates a valve corresponding to each of the zones at blocks 657, 660, and 663, respectively.

After the valves of each of the zones have been opened, or alternatively, if the temperature control system 10 is a single zone system (“No” at block 648), the pre-crank sub-process 600 proceeds to block 670 and determines if the temperature control system 10 is a truck unit. If the temperature control system 10 is a truck unit (“Yes” at block 670), the pre-crank sub-process 600 sets an engine crank-start timer at block 673. In some embodiments, the timer is set at about 30 seconds.

The pre-crank sub-process 600 then enters an engine crank sequence (described below). If the temperature control system 10 is not a truck unit (“No” at block 670), the pre-crank sub-process 600 determines if the engine control system 300 requires a cold engine start at block 676. If the engine control system 300 requires a cold engine start at block 676 (“Yes” at block 676), the pre-crank sub-process 600 determines the value of the failed-to-crank counter at block 679, and the failed-to-start counter at block 682, respectively.

If both the failed-to-crank counter and the failed-to-start counter have a predetermined value (e.g., 0), the pre-crank sub-process 600 sets the engine crank-start timer to a predetermined value (e.g., about 6 seconds) at block 685, and enters the engine crank sequence. Otherwise, if the engine control system 300 does not require a cold engine start (“No” at block 676), the pre-crank sub-process 600 sets the engine crank-start timer to a predetermined value (e.g., about 15 seconds) at block 688, and enters the engine crank sequence 700. If any of the failed-to-crank counter and the failed-to-start counter has a null value, the pre-crank sub-process 600 sets the engine crank-start timer to another predetermined value (e.g., about 30 seconds) at block 691, and enters the engine crank sequence 700.

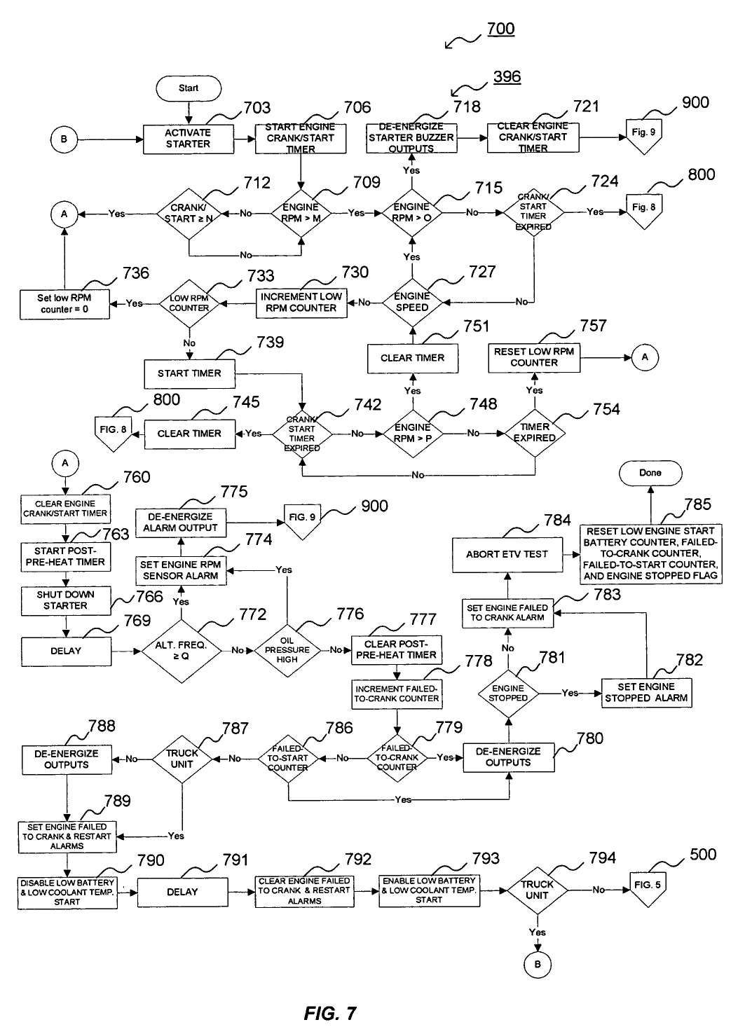

FIG. 7 illustrates a crank-start sequence or a crank-start sub-process 700 of the engine starting process 396. In some embodiments, the crank-start sequence 700 lasts for about 6 seconds for a first crank, and about 30 seconds for a second cranking, while other amounts of time can also be used depending on the application.

During the first cranking, current is drawn from the battery 312 such that the battery 312 generates a small amount of internal heat. In some embodiments, the amount of current drawn is about 600 amps. In this manner, the battery 312 gains additional battery strength for the second cranking cycle given that battery strength or power diminishes significantly when the ambient temperature is significantly below freezing (e.g., about −30° C.).

Furthermore, during the first cranking, a first combustion within the cylinder 316 is achieved for a limited time (e.g., less than about 6 seconds). The first combustion generates a small amount of heat within the cylinders 316, which is instrumental in achieving continuous combustion during the second cranking cycle (described below). The engine 8 typically does not start during the first cranking because the cylinder 316 has not attained enough heat therein to support continuous combustion. Before initiating a second cranking, the method 396 can include a delay (e.g., between about 10 seconds and about 15 seconds) to allow the heat to be distributed through the battery 312 and/or to allow the heat to be distributed through the engine body 308 or a portion of the engine body 308.

During a second cranking, which can last for about 30 seconds, the engine 8 is able to start because the engine cylinders 316 have sufficient residual heat energy from the first cranking, and the battery 312 has sufficient battery power or strength due to the internal heat and subsequent temperature rise discussed above. In this manner, the engine starting process 312 prevents and/or limits the need to repeatedly crank the engine 8, thereby preventing an operator from unnecessarily draining the battery 312 during repeated failed engine starts.

With reference to FIG. 7, at block 703, the crank-start sub-process 700 activates a starter motor, and increments an engine/start timer (between about 6 and about 30 seconds) at block 706. When the engine starter motor is started, speeds of the engine 8 are recorded by the speed sensor 324, and processed in real time by the controller 344.

If the speed sensor 324 determines that the speed of the engine 8 is below a predetermined threshold value M (e.g., 40 revolution per minute) (“No” at block 709), the crank-start sub-process 700 proceeds to determine if the crank-start timer is set for a value greater than a predetermined threshold N (e.g., about 3 seconds), at block 712. If the crank-start timer is set for a value less than the predetermined threshold N (“No” at 709), the controller 344 continues to monitor the speed of the engine 8, thus repeating block 709.

Otherwise, if the crank-start timer is set for a value greater than the predetermined threshold M (“Yes” at block 709), the crank-start sub-process 700 continues to monitor the engine speed at block 715. If the speed of the engine 8 is above another threshold value O (e.g., 800 revolutions per minute) (“Yes” at block 715), the crank-start sub-process 700 shuts down the starter motor and the alarm outputs at block 718. The crank-start sub-process 700 then clears the engine crank-start timer at block 721, and enters a successful-start sequence. It should be noted that the threshold values M, N, and O are selected based on the engine 8 size and the desired output. According, in other embodiments, other threshold values M, N, and O can also or alternately be used.

If the speed of the engine 8 is less than or has not reached the predetermined threshold value (“No” at act 724), the crank-start sub-process 700 determines if the engine crank-start timer has expired at block 724. If the engine crank-start timer has expired (“Yes” at block 724), the crank-start sub-process 700 enters a failure-to-start sub-process (described below). However, if the engine crank-start timer has not expired (“No” at block 724), the crank-start sub-process 700 monitors the engine speed at block 727.

If the engine speed is greater than the predetermined threshold O (“Yes” at block 727), the crank-start sub-process 700 returns to block 715. However, if the engine speed is less than the predetermined threshold O (“No” at block 727), the crank-start sub-process 700 increments a low RPM counter at block 730, and determines if the value of the low RPM counter is greater than a predetermined value at block 733. If the low RPM counter is above the predetermined value (“Yes” at block 733), as determined at block 733, the crank-start sub-process 700 resets the low RPM counter at block 736. Otherwise, if the low RPM counter is below the predetermined value (“No” at block 733), the crank-start sub-process 700 starts a timer (e.g., about a three second timer) at block 739, and determines if the crank-start timer has expired at block 742.

If the crank-start timer expires (“Yes” at block 742), the crank-start sub-process 700 clears the timer (e.g., a 3 second timer) at block 745, and enters the failed-to-start sequence (described below). If the crank-start timer does not expire (“No” at block 742), the crank-start sub-process 700 determines if the engine speed has exceeded a low threshold P (e.g., 40 revolutions per minute) at block 748.

If the engine speed has exceeds the low threshold P (“Yes” at block 748), the crank-start sub-process 700 clears a timer (e.g., a 3 second timer) at block 751, and the crank-start sub-process 700 returns to block 727. However, if the engine speed is below the low threshold P (“No” at block 748), the crank-start sub-process 700 determines if the timer (e.g., a three second timer) has expired at block 754, and resets the low RPM counter at block 757.

Thereafter, the crank-start sub-process 700 clears the crank-start timer at block 760, starts a post preheat timer (such as a 10 second timer) at block 763, de-energizes the starter output at block 766, and enters a delay (e.g., about a 5 second delay) at block 769. The crank-start sub-process 700 then checks an alternator frequency at block 772. If the alternator frequency is above a desired threshold Q (e.g., about 100 Hz) (“Yes” at block 772), the crank-start sub-process 700 sets an alarm corresponding to an engine RPM sensor failure at block 774, de-energizes the alarm output at block 775, and enters a successful-start sequence (described below). However, if the alternator frequency is below the desired threshold Q (“No” at block 772), the crank-start sub-process 700 determines if an oil pressure input is high at block 776.

If the oil pressure input is high at block 776 (“Yes” at block 776), the crank-start sub-process 700 returns to block 774. Otherwise, if the oil pressure input is not high (“No” at block 776), the crank-start sub-process 700 clears the post preheat timer at block 777, increments the failed-to-crank counter at block 778, and determines the value of the failed-to-crank counter at block 779.

If the value of the failed-to-crank counter at block 779 equals a predetermined number (e.g., 2) (“Yes” at block 779), the crank-start sub-process 700 determines that the engine 8 has failed to crank the predetermined number of times. The crank-start sub-process 700 then proceeds to de-energize all outputs except for the status lights at block 780, and determines if the engine 8 has stopped at block 781. If the engine 8 has stopped (“Yes” at block 781), the crank-start sub-process 700 proceeds to set an alarm corresponding to a stopped engine at block 782. Otherwise, if the engine 8 has not stopped (“No” at block 781), or alternatively, after the alarm corresponding to a stopped engine at block 782 has been set, the crank-start sub-process 700 sets an alarm corresponding to failure to crank at block 783. The crank-start sub-process 700 then proceeds to abort all ETV tests and ensures that no ETV alarm is set at block 784, resets a number of counters and flags (e.g., a low engine start battery counter, a failed-to-crank counter, a failed-to-start counter, and a stopped-engine flag) at block 785, and terminates.

If the failed-to-crank counter has not reached the predetermined number (such as 2) (“No” at block 779), the crank-start sub-process 700 proceeds to determine the value of the failed-to-start counter at block 786. If the value of the failed-to-start counter at block 786 reaches 1 (“Yes” at block 786), the crank-start sub-process 700 returns to block 780. Otherwise, if the value of the failed-to-start counter at block 786 has not reached 1 (“No” at block 786), the crank-start sub-process 700 determines if the temperature control system 10 is a truck unit at block 787.

If the temperature control system 10 is not a truck unit (“No” at block 787), the crank-start sub-process 700 de-energizes all outputs at block 788, sets an alarm corresponding to a failure to crank the engine at block 789, disables a low battery and low water temperature start at block 790, and enters a delay (e.g., about 7 seconds) at block 791. If the temperature control system 10 is a truck unit (“Yes” at block 787), the crank-start sub-process 700 returns to block 789.

After the crank-start sub-process 700 completes the delay in block 791, the crank-start sub-process 700 clears alarms corresponding to failure to crank engine and to a null restart at block 792. Subsequently, the crank-start sub-process 700 enables the low battery and low engine coolant temperature start at block 793, and determines again if the temperature control system 10 is a truck unit at block 794.

If the temperature control system 10 is a truck unit (“Yes” at block 794), the crank-start sub-process 700 returns to block 703. Otherwise, if the temperature control system 10 is not a truck unit (“No” at block 794), the crank-start sub-process 700 returns to the preheat sub-process 500 of FIG. 5.

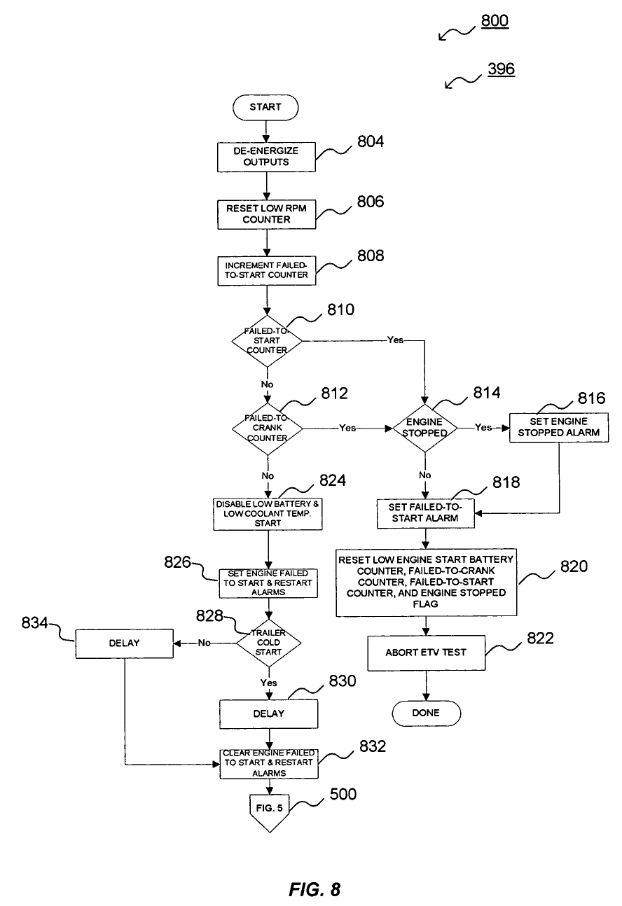

FIG. 8 illustrates a fail-to-start sequence or a fail-to-start sub-process 800 of the engine starting process 396. The exemplary fail-to-start sequence provides an overall delay to allow the heat within the battery 312 from a previous cranking to warm the interior of the battery 312 and to strengthen the battery 312 for an additional or a second cranking cycle.

The fail-to-start sub-process 800 starts with de-energizing all outputs at block 804, resetting a low speed counter at block 806, incrementing the failed-to-start counter at block 808, and determining if the failed-to-start counter has reached a predetermined number (e.g., 2) at block 810.

If the failed-to-start counter has not reached the predetermined number (“No” at block 810), the fail-to-start sub-process 800 determines the value of the failed-to-crank counter at block 812. If the failed-to-start counter has reached the predetermined number (“Yes” at block 810), the fail-to-start sub-process 800 determines if a flag corresponding to a stopped engine has been set at block 814. If the flag corresponding to a stopped engine has been set (“Yes” at block 814), the fail-to-start sub-process 800 sets an alarm corresponding to a stopped engine at block 816, and sets an alarm corresponding to engine failed to start at block 818.

If the flag corresponding to a stopped engine has not been set (“No” at block 814), the fail-to-start sub-process 800 moves to block 818. Subsequently, the fail-to-start sub-process 800 resets a number of counters and flags (e.g., a low engine start battery counter, a failed-to-crank counter, a failed-to-start counter, and a stopped-engine flag) at block 820, aborts all ETV tests at block 822, and terminates.

If the value of the failed-to-crank counter at block 812 reaches the predetermined number, the fail-to-start sub-process 800 repeats at block 814. Otherwise, if the value of the failed-to-crank counter at block 812 has not reached the predetermined number (“No” at block 812), the fail-to-start sub-process 800 disables the low battery and low water temperature start at block 824, sets alarms corresponding to engine failed to start and a null restart at block 826, and determines if a cold start is required at block 828.

If a cold start is required (“Yes” at block 828), the fail-to-start sub-process 800 initiates a delay (e.g., about a 12 second delay) at block 830, clears the alarm corresponding to engine failed to start and a null restart at block 832, and enters the preheat sub-process 500 of FIG. 5. Otherwise, if a cold start is not required (“No” at block 828), the fail-to-start sub-process 800 initiates a delay (e.g., about a 30 second delay) at block 834, and returns to block 832. In this manner, the engine starting process 396 can use two or more delays for the preheat sub-process 500 of FIG. 5 to ensure that heat is distributed through the engine body 308 and/or the battery 312.

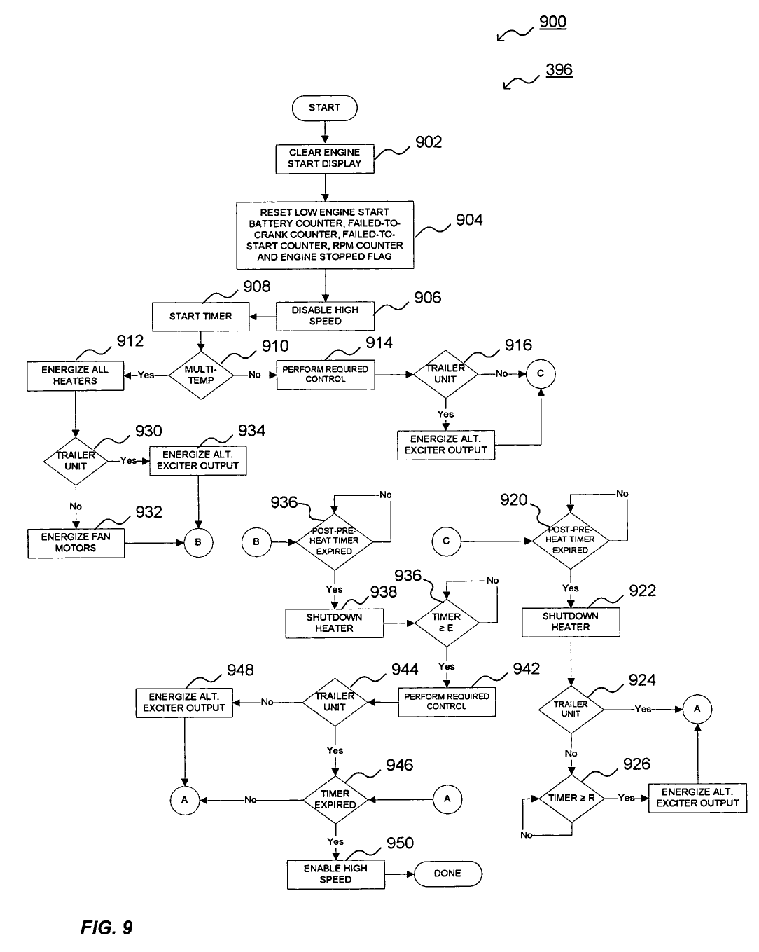

FIG. 9 illustrates a successful-start sequence or a successful-start sub-process 900 of the engine starting process 396. At block 902, the successful-start sub-process 900 clears all displays on the HMI 360, and resets a number of counters and flags (e.g., a low engine start battery counter, a failed-to-crank counter, a failed-to-start counter, a low RPM counter, and a stopped-engine flag) at block 904. In some embodiments, the successful-start sub-process 900 also notifies the HMI 360 of a successful engine start.

The successful-start sub-process 900 disables high speed operation at block 906, starts a long timer at block 908 (e.g., about 2 minutes), and determines if the temperature control system 10 is a multi-temperature zone unit at block 910. If the temperature control system 10 is a multi-temperature zone unit (“Yes” at block 910), the successful-start sub-process 900 energizes all hot gas valves or solenoids in all zones at block 912. If the temperature control system 10 is not a multi-temperature zone unit (“No” at block 910), the successful-start sub-process 900 attends to other controls required by the temperature control system 10 at block 914, and determines if the temperature control system 10 is a trailer unit at block 916.

If the temperature control system 10 is a trailer unit (“Yes” at block 916), the successful-start sub-process 900 energizes the alternator exciter output at block 918. The successful-start sub-process 900 then determines if the post preheat timer (e.g., about a 10 second timer) has expired at block 920. The successful-start sub-process 900 proceeds to de-energize preheat output after the post-preheat timer has expired at block 922. The successful-start sub-process 900 determines if the temperature control system 10 is a trailer unit at block 924.

If the temperature control system 10 is not a trailer unit (“No” at block 926), the successful-start sub-process 900 proceeds to determine if the long timer is greater than a predetermined amount of time R (e.g., about 30 seconds) at block 926. Once the long timer records a time greater than the predetermined amount of time R (“Yes” at block 926), the successful-start sub-process 900 energizes the alternator exciter output at block 928.

Referring back to block 912, after the successful-start sub-process 900 has energized all hot gas valves or solenoids in all zones at block 912, the successful-start sub-process 900 determines if the temperature control system 10 is a trailer unit at block 930. If the temperature control system 10 is not a trailer unit (“No” at block 930), the successful-start sub-process 900 energizes a plurality of zone fan motors at block 932. However, if the temperature control system 10 is a trailer unit (“Yes” at block 930), the successful-start sub-process 900 energizes the alternator exciter output at block 934.

After the successful-start sub-process 900 has energized the alternator exciter output at block 934, or alternatively, after the successful-start sub-process 900 has energized the fan motors at block 932, the successful-start sub-process 900 determines if the post-preheat timer has expired at block 936. The successful-start sub-process 900 proceeds after the post-preheat timer has expired at block 936 to de-energize the post-preheat output at block 938.

After the successful-start sub-process 900 has de-energized the post-preheat output at block 938, the successful-start sub-process 900 determines if the long timer is greater than a predetermined amount of time E (e.g., about 30 seconds) at block 940. Once the long timer is greater than the predetermined amount of time E (“Yes” at block 940), the successful-start sub-process 900 attends to other required unit control functions at block 942. Thereafter, the successful-start sub-process 900 determines if the temperature control system 10 is a trailer unit at block 944.

If the temperature control system 10 is a trailer unit (“Yes” at block 944), or alternatively, after the successful-start sub-process 900 has energized the alternator exciter output at block 928, the successful-start sub-process 900 proceeds to determine if the long timer has expired at block 946. If the temperature control system 10 is not a trailer unit (“No” at block 944), the successful-start sub-process 900 energizes the alternator exciter output at block 948, and the successful-start sub-process 900 returns to block 946. Once the long timer has expired as determined at block 946, the successful-start sub-process 900 proceeds to enable high speed operations at block 950, and terminates.

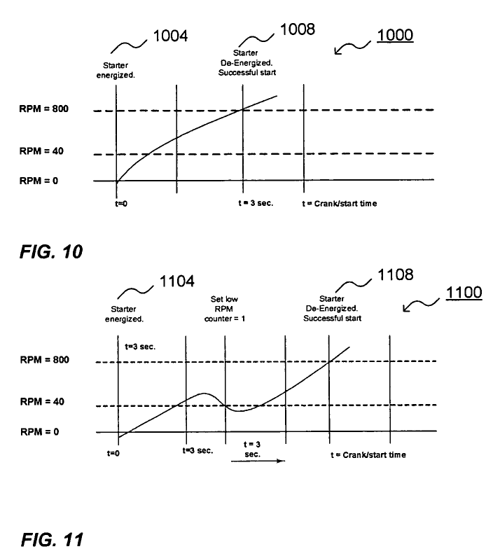

FIGS. 10 and 11 are plots 1000, 1100 of engine speed versus time for two successful starts of an engine. FIG. 10 shows that the engine 8 runs at a desired speed of about 800 revolutions per minute after 3 seconds (i.e., 3 seconds after the starter has been energized 1008). FIG. 11 shows that the engine 8 has failed to start initially after the starter has been energized at 1104. After the second preheat and the second cranking, the engine 8 achieves a desired speed of more than about 800 revolutions at 1108.

Various features and advantages of the invention are set forth in the following claims.

What is claimed is:

1. A method of operating an internal combustion engine of a vehicle in an environment having an ambient temperature below about 0 degrees Celsius, the engine having a battery and an engine body supporting a piston, the method comprising the acts of:
initiating a first heating operation to warm air entering the engine;
igniting fuel in the engine body to warm the engine and causing limited movement of the piston relative to the engine body;
drawing power from the battery to generate heat in the battery;
distributing the heat through the battery for a predetermined period of time before initiating a second heating operation to warm the air in the engine; and
starting the internal combustion engine after the heat is distributed through the battery, causing the piston to continually reciprocate through the engine body.

2. The method of claim 1, further comprising sensing the ambient temperature and preventing initiation of the first heating operation when the ambient temperature is above about 10 degrees Celsius.

3. The method of claim 1, wherein initiating the first heating operation includes warming the air entering the engine for between about 40 seconds and about 60 seconds before igniting the fuel in the engine body.

4. The method of claim 1, wherein the engine includes a heating element, and wherein initiating the first heating operation to warm air entering the engine includes drawing power from the battery to operate the heating element and warming the battery.

5. The method of claim 4, wherein initiating the second heating operation to warm the air in the engine includes drawing power from the battery to operate the heating element and warming the battery.

6. The method of claim 1, wherein the predetermined period of time is between about 10 seconds and about 15 seconds.

7. The method of claim 1, further comprising continuing the second heating operation for at least about 30 seconds.

8. The method of claim 1, wherein igniting the fuel in the engine body to warm the engine causes limited combustion of the fuel in the engine body, and wherein starting the internal combustion engine causes substantially continuous combustion of the fuel in the engine body.

9. An internal combustion engine of a vehicle, the internal combustion engine comprising:
an engine body having an air inlet;
a sensor for recording an ambient temperature away from the engine body;
a heater positioned adjacent to the air inlet for heating air entering the engine body;
a piston supported in the engine body for reciprocating movement through the engine body;
a battery electrically connected to the heater to supply power to the heater; and
a controller operable to activate the heater to warm air entering the engine, initiate combustion of fuel in the engine body to warm the engine without causing continued movement of the piston relative to the body, and draw power from the battery before starting the engine;
wherein the controller is operable to delay starting of the engine for a predetermined time to allow heat to be distributed through the battery before causing the piston to continually reciprocate through the engine body.

10. The internal combustion engine of claim 9, wherein the battery is operable to generate the heat during powering of the heater.

11. A method of operating an internal combustion engine of a vehicle in an environment having an ambient temperature of below about 0 degrees Celsius, the engine having a battery and an engine supporting a piston, the method comprising the acts of:
activating a heating element to warm the engine body;
cranking the engine to warm the engine and causing limited movement of the piston relative to the engine body;
drawing power from the battery to generate heat in the battery; and
distributing the heat through the battery for a predetermined period of time before starting the internal combustion engine and causing the piston to continually reciprocate through the body.

12. The method of claim 11, wherein cranking the engine includes igniting fuel in the engine body.

13. The method of claim 11, wherein activating the heating element includes performing a first heating operation, and further comprising activating the heating element to perform a second heating operation to warm the air in the engine before starting the internal combustion engine.

14. The method of claim 13, wherein initiating the second heating operation to warm the air in the engine includes drawing power from the battery and warming the battery.

15. The method of claim 11, further comprising sensing the ambient temperature and preventing activation of the first heating element when the ambient temperature is above about 10 degrees Celsius.

16. The method of claim 1, wherein activating the heating element includes warming the air entering the engine for between about 40 seconds and about 60 seconds before cranking the engine to warm the engine.

17. The method of claim 11, wherein activating the heating element includes drawing power from the battery and warming the battery.

18. The method of claim 11, wherein the predetermined period of time is between about 10 seconds and about 15 seconds.

19. The method of claim 11, further comprising continuing the second heating operation for at least about 30 seconds.

20. The method of claim 11, wherein cranking the engine includes igniting fuel in the engine body to warm the engine, and wherein starting the internal combustion engine includes causing substantially continuous combustion of the fuel in the engine body.
